(19) United States
(12) Patent Application Publication
(10) Pub. No.: US 2013/0198162 A1
(43) Pub. Date: Aug. 1, 2013

(54) METHODS FOR SEARCHING ONE OR MORE BUSINESS ENTITIES UTILIZING A WEB SERVICE AND A BROWSER PLUG-IN APPLICATION

(71) Applicant: Rasmus Refer, Frederiksberg (DK)

(72) Inventor: Rasmus Refer, Frederiksberg (DK)

(21) Appl. No.: 13/754,621

(22) Filed: Jan. 30, 2013

Related U.S. Application Data
(60) Provisional application No. 61/592,495, filed on Jan. 30, 2012.

(51) Int. Cl. G06F 17/30

(52) U.S. Cl. CPC G06F 17/30867
USPC 707/710

(57) ABSTRACT

A plurality of methods for searching one or more business entities utilizing a web service and a browser plug-in application based on one or more keywords, a domain name or a user's geographic location and displaying the relevant business entities. The one or more keywords will be based on selected text entered into a web service and a browser plug-in application. The search process is initiated based on selecting one or more keywords from a text, double-clicking on the one or more keywords, selecting a right-click context menu option and clicking on a browser extension button. The server receives the request and carries out a search in a database in communication with the web service. The search is based on which relevant business entities are found and a result is created, which is sent back to the browser, where the received search results are displayed in a browser pop-up window.

This application claims priority to U.S. Provisional Application 61/592,495 filed on Jan. 30, 2012, the entire disclosure of which is incorporated by reference.

### BACKGROUND OF THE INVENTION

1. Field of the Invention

The present invention is a plurality of methods for searching one or more business entities. More specifically, the present invention is a plurality of methods for searching one or more business entities utilizing a web service and a browser plug-in application.

2. Description of the Related Art

There are a lot of business entities globally available. Everyone has to search for various business providers when required. Searching for business providers is a time consuming and cumbersome task. Looking for a business provider through one or more general search engines requires a lot of effort and time.

### BRIEF SUMMARY OF THE INVENTION

The present invention is a plurality of methods for searching one or more business entities. More specifically, the present invention is a plurality of methods for searching one or more business entities utilizing a web service and a browser plug-in application.

The present invention is a plurality of methods for searching one or more business entities utilizing a web service and a browser plug-in application based on one or more keywords, a domain name or a user's geographic location and displaying the relevant one or more business entities. The one or more keywords will be based on selected text entered into a web service and a browser plug-in application. The search process is initiated based on selecting one or more keywords from a text, double-clicking on the one or more keywords, selecting a right-click context menu option and clicking on a browser extension button. The server receives the request and carries out a search in a database in communication with the web service. The search is based on which relevant one or more business entities are found and a search result is created, which is sent back to the browser, where the received search result is displayed in a browser pop-up window. In case the one or more keywords is not selected by the user in the webpage, the domain name of the webpage currently displayed in the browser window is used as the one or more keywords and the domain name based search is carried out by the server. The server can generate the search result based on the geographic location of the client browser as well.

It is an object of the present invention to provide a method for searching one or more business entities utilizing a web service and a browser plug-in application that searches according to one or more keywords.

It is an object of the present invention to provide a method for searching one or more business entities utilizing a web service and a browser plug-in application that searches according to a domain name.

It is an object of the present invention to provide a method for searching one or more business entities utilizing a web service and a browser plug-in application that searches according to a domain geographic location.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a system to search one or more business entities, in accordance with one embodiment of the present invention.

FIG. 2 illustrates a method for searching one or more business entities utilizing a keyword search, in accordance with one embodiment of the present invention.

FIG. 3 illustrates a method for searching one or more business entities utilizing a domain name search, in accordance with one embodiment of the present invention.

FIG. 4 illustrates a method for searching one or more business entities utilizing a browser plug-in application, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

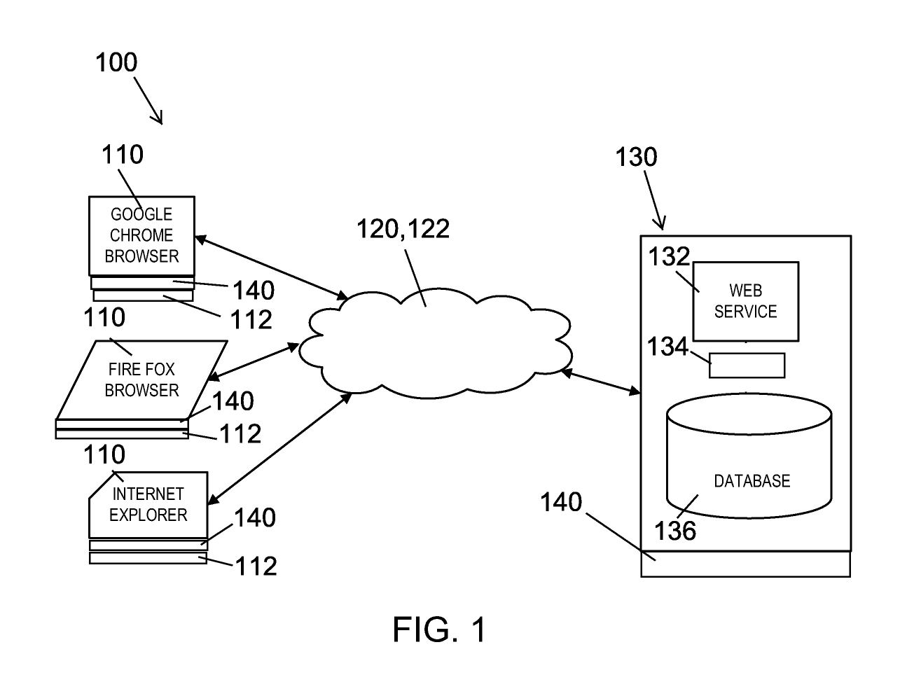

FIG. 1 illustrates a system overview of a system 100 to search one or more business entities, in accordance with one embodiment of the present invention.

The system 100 includes a selected browser 110, a communications system 120, a server system 130 and a browser plug-in application 140. The selected browser 110 is utilized to input information to search the one or more business entities. The information is a selected one of one or more keywords, one or more domain names and a geographic location of the selected browser 110. The selected browser 110 is utilized with a client system 112. The client system 112 is a selected one of a desktop computer, a laptop computer and a tablet computer. The client system 112 can also be a cell phone with a browsing capacity and an operating system or SMARTPHONE®.

The communications system 120 is in communication with the selected browser 110. The communications system 120 can be the Internet 122 or a selected one of a local area network, a wide area network, a wireless network, a telephone network and an intranet.

The server system 130 includes a web service 132, a processor 134 and a database 136. The server system 130 is in communication with the selected browser 110 over the communication system 120. The server system 130 searches the one or more keywords, the one or more domain names and the geographic location of the selected browser 110.

The browser plug-in application 140 is utilized in the selected browser 110 and is provided to facilitate the server system 130 to search the one or more keywords, the one or more domain names and the geographic location of the selected browser 110. The server system 130 and the browser plug-in application 140 render a selected one of one or more business entity related web pages and one or more documents. In the browser plug-in application 140, a user can double click on a word on the selected one of one or more business entity related web pages and one or more documents.

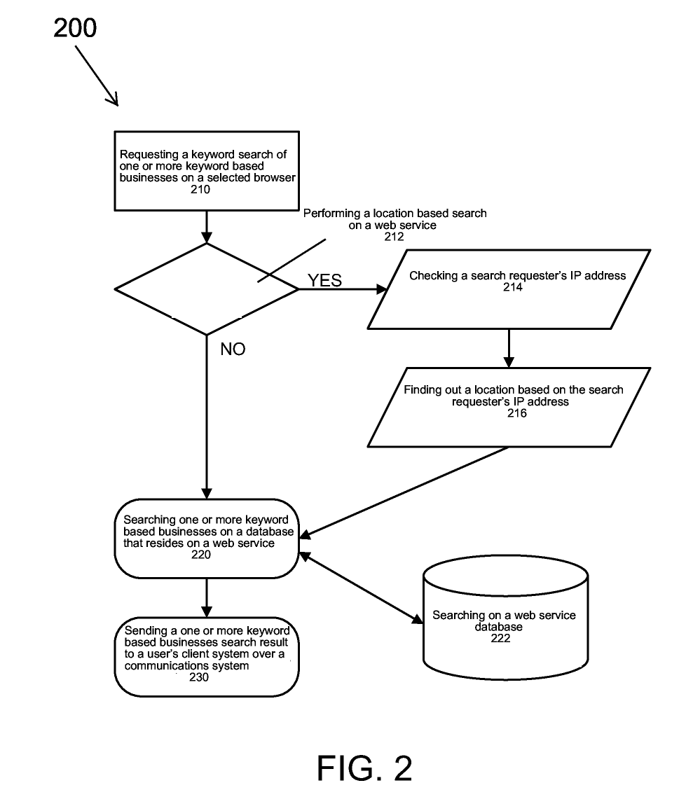

FIG. 2 illustrates a method 200 for searching one or more business entities utilizing a keyword search, in accordance with one embodiment of the present invention.

The method 200 includes the steps of requesting a keyword search of one or more keyword based businesses on a selected browser 210, searching one or more keyword based businesses on a database that resides on a web service 220 and sending a one or more keyword based businesses search result to a user's client system over a communications system 230. The requesting a keyword search of one or more keyword based businesses on a selected browser step 210 can include performing a location based search on a web service 212. The performing a location based search 212 includes checking a search requester's IP address 214 and finding out a location based on the search requester's IP address 216. The searching one or more keyword based businesses on a database that resides on a web service 220 includes searching on a web service database 222 such as masterseek.com or any other suitable website. The sending a one or more keyword based businesses search result to a user's client system over a communications system step 230 is typically performed over the Internet but can be performed over any suitable communications network. The selected browser is utilized with the user's client system. The user's client system is a selected one of a desktop computer, a laptop computer and a tablet computer. The user's client system can also be a cell phone with a browsing capacity and an operating system or SMARTPHONE®.

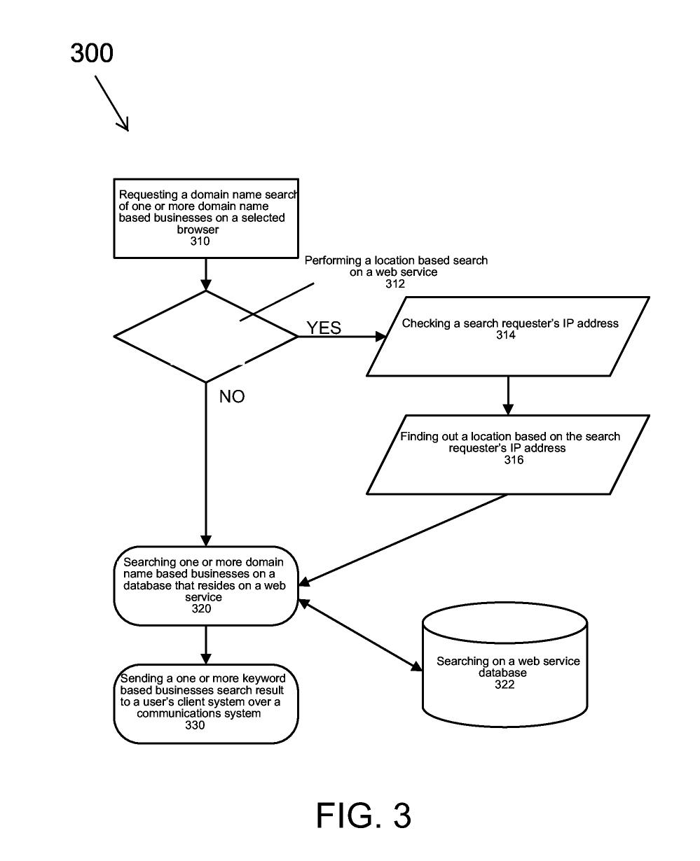

FIG. 3 illustrates a method 300 for searching one or more business entities utilizing a domain name search, in accordance with one embodiment of the present invention.

The method 300 includes the steps of requesting a domain name search of one or more domain name based businesses on a selected browser 310, searching one or more domain name based businesses on a database that resides on a web service 320 and sending a one or more domain name based businesses search result to a user's client system over a communications system 330. The requesting a domain name search of one or more domain name based businesses on a selected browser step 310 can include performing a location based search on a web service 312. The performing a location based search 312 includes checking a search requester's IP address 314 and finding out a location based on the search requester's IP address 316. The searching one or more domain name based businesses on a database that resides on a web service 320 includes searching on a web service database 322 such as masterseek.com or any other suitable website. The sending a one or more domain name based businesses search result to a user's client system over a communications system step 330 is typically performed over the Internet but can be performed over any suitable communications network. The selected browser is utilized with the user's client system. The user's client system is a selected one of a desktop computer, a laptop computer and a tablet computer. The user's client system can also be a cell phone with a browsing capacity and an operating system or SMARTPHONE®.

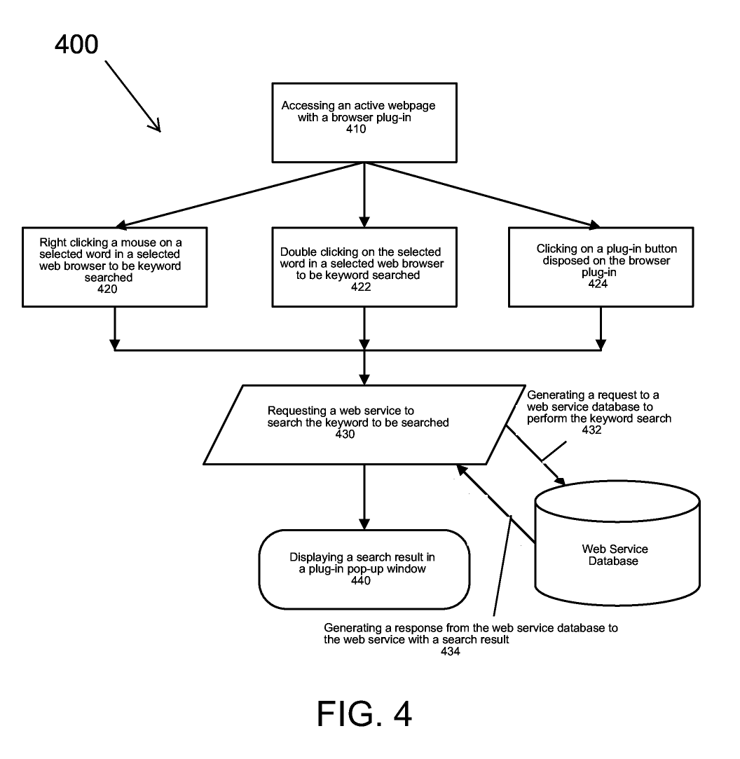

FIG. 4 illustrates a method 400 for searching one or more business entities utilizing a browser plug-in application and a web service, in accordance with one embodiment of the present invention.

The method 400 includes the steps of accessing an active webpage with a browser plug-in application 410, right clicking a mouse on a selected word in a selected web browser to be keyword searched 420, requesting a web service to search the keyword to be searched 430 and displaying a search result in a plug-in pop-up window 440.

The accessing an active webpage with a browser plug-in application step 410 utilizes a browser plug-in application for following one of three implemented browsers with similar features that include GOOGLE CHROME™, FIREFOX™ and INTERNET EXPLORER®. The browsers can be accessed with a client system such as a desktop computer, a laptop computer, a tablet computer or a cell phone with a browser capability and an operating system or a SMARTPHONE®. The selected browser is utilized with the client system.

The right clicking a mouse on a selected word in a selected web browser to be keyword searched step 420 can be replaced with double clicking on the selected word in a selected web browser to be keyword searched 422. The right clicking a mouse on a selected word in a selected web browser to be keyword searched step 420 can also be replaced with clicking on a plug-in button disposed on the browser plug-in application 424.

The generic operation implemented for a browser plug-in application is a double click on any word in the web browser. If a profile exists in the database for a selected word, a default profile tab with the content is clicked. A search results tab displays the one or more related business entities by searching a country-based Internet protocol or IP. A brands tab shows the brands available from around the globe without an IP look-up. While clicking on the brands tab or a related search items tab, it will load the profile in the profile tab accordingly.

If the profile does not exist in a database for a selected word, but the related search items are found, the search results tab shows the related one or more business entities by looking at a default country based IP. The brands tab displays the brands available around the globe without an IP look-up. When clicking on the brands tab or the related search items tab, it will load the profile in the profile tab accordingly. If the profile does not exist in the database for a selected word, the related search items will also not be found. In this case, a load pop-up with a no results found message will be displayed.

The requesting a web service to search the keyword to be searched step 430 includes generating a request to a web service database to perform the keyword search 432. The web service database then includes generating a response from the web service database to the web service with a search result 434.

If a profile exists in the database for a selected word, a default profile tab with the content is clicked. A search results tab displays the one or more related business entities by searching a country-based Internet protocol or IP. A brands tab shows the brands available from around the globe without an IP look-up. While clicking on the brands tab or a related search items tab, it will load the profile in the profile tab accordingly.

If the profile does not exist in a database for a selected word, but the related search items are found, the search results tab shows the one or more related business entities by looking at a default country based IP. The brands tab displays the brands available around the globe without an IP look-up. When clicking on the brands tab or the related search items tab, it will load the profile in the profile tab accordingly. If the profile does not exist in the database for a selected word, the related search items will also not be found. In this case, a load pop-up with a no results found message will be displayed.

The displaying a search result in a plug-in pop-up window step 440 includes displaying the search result from the web service database generated by the generating a response from the web service database to the web service with a search result 442.

If a profile exists in the database for a selected word, a default profile tab with the content is clicked. A search results tab displays the one or more related business entities by searching a country-based Internet protocol or IP. A brands tab shows the brands available from around the globe without an IP look-up. While clicking on the brands tab or a related search items tab, it will load the profile in the profile tab accordingly.

If a URL based profile does not exist in a database for a selected word, a load pop-up with a no results found message will be displayed.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method for searching one or more business entities utilizing a web service and a browser plug-in application, comprising:
requesting a keyword search of one or more keyword based businesses on a selected browser;
searching one or more keyword based businesses on a database that resides on the web service; and
sending a one or more keyword based businesses search result to a user's client system over a communications system.

2. The method according to claim 1, wherein the requesting a keyword search of one or more keyword based businesses on a selected browser step includes performing a location based search on the web service.

3. The method according to claim 2, wherein the performing a location based search includes checking a search requester's IP address.

4. The method according to claim 3, wherein the performing a location based search includes finding out a geographic location based on the search requester's IP address.

5. The method according to claim 1, wherein the sending a one or more keyword based businesses search result to a user's client system over a communications system step is performed over the Internet.

6. The method according to claim 1, wherein the user's client system is a selected one of a desktop computer, a laptop computer and a tablet computer.

7. The method according to claim 1, wherein the user's client system is a cell phone with a browsing capacity and an operating system.

8. A method for searching one or more business entities utilizing a keyword search utilizing a web service and a browser plug-in application, comprising:
requesting a domain name search of one or more domain name based businesses on a selected browser;
searching one or more domain name based businesses on a database that resides on the web service; and
sending a one or more domain name based businesses search result to a user's client system over a communications system.

9. The method according to claim 8, wherein the requesting a domain name search of one or more keyword based businesses on a selected browser step includes performing a location based search on the web service.

10. The method according to claim 9, wherein the performing a location based search includes checking a search requester's IP address.

11. The method according to claim 10, wherein the performing a location based search includes finding out a location based on the search requester's IP address.

12. The method according to claim 8, wherein the sending a one or more keyword based businesses search result to the user's client system over a communications system step is performed over the Internet.

13. The method according to claim 8, wherein the user's client system is a selected one of a desktop computer, a laptop computer and a tablet computer.

14. The method according to claim 8, wherein the user's client system is a cell phone with a browsing capacity and an operating system.

15. A method for searching one or more business entities utilizing a web service and a browser plug-in application:
accessing an active webpage with a browser plug-in application;
double clicking a mouse on any word in a selected web browser to be keyword searched; and
clicking on a plug-in button on the browser plug-in application to search the selected keyword.

16. The method according to claim 15, wherein the right clicking a mouse on a selected word in a selected web browser to be keyword searched step is replaced with double clicking on the selected word in the selected web browser to be keyword searched.

17. The method according to claim 16, wherein the right clicking a mouse on a selected word in a selected web browser to be keyword searched step is replaced with clicking on a plug-in button disposed on the browser plug-in application.

18. The method according to claim 16, wherein the requesting the web service to search the keyword to be searched step includes generating a request to a web service database to perform the keyword search.

19. The method according to claim 18, wherein the web service database further comprising the step of generating a response from the web service database to the web service with a search result.

20. The method according to claim 15, wherein accessing an active webpage with the browser plug-in application is performed with a selected one of a desktop computer, a laptop computer, a tablet computer and a cell phone with a browsing capacity and an operating system.
